(19) United States
(12) Patent Application Publication
(10) Pub. No.: US 2007/0071520 A1
(43) Pub. Date: Mar. 29, 2007

(54) IMAGE HEATING APPARATUS

(75) Inventors: TAKAAKI TSUCHIYA, Tokyo (JP); YASUHIRO HAYASHI, Moriya-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 11/469,622

(22) Filed: Sep. 1, 2006

(30) Foreign Application Priority Data
Sep. 13, 2005 (JP) 2005-266011

(51) Int. Cl. G03G 15/20

(52) U.S. Cl. 399/329

(57) ABSTRACT

The invention provides a fixing device capable of preventing extreme decrease of pressure in a fixing nip. The fixing device includes an endless fixing belt for fixing a toner image on a recording material, a roller for suspending the fixing belt, a pressure pad for pressing the fixing belt provided without contact with the roller, and pressing means provided in press contact with the fixing belt for forming a fixing nip from the pressure pad to the roller, in which the relation of
Y≧1×10⁸X²+2×10⁶X, and
0<Y<2.6×10⁷ Is satisfied, where y is the product of young's modulus of the base material of the fixing belt and thickness (Mpa·mm), and x is the product of length of gap between the pressure pad and the roller in moving direction of the fixing belt and pressure per unit area at the gap (Mpa·mm).

### BACKGROUND OF THE INVENTION

1. Field of the Invention

The invention relates to an image heating apparatus for heating an image on a recording material. Such image heating apparatus includes a fixing device for fixing an unfixed image on a recording material, a gloss enhancing device for enhancing the gloss of image by reheating the image fixed on a recording material. The image heating apparatus is used, for example, in copier, printer, facsimile unit, compound machine having such plural functions, and other image forming apparatus.

2. Description of the Related Art

Japanese Patent Application Laid-Open (JP-A) 2004-191512 discloses a belt fixing device using a belt in an image forming apparatus of electrophotographic type. This belt fixing device uses a fixing belt and a pressure roller, and two pad members for pressing the fixing belt toward the pressure roller are disposed apart from each other in the recording material conveying direction.

JP-A No. 2004-264531 discloses a twin belt fixing device using a fixing belt and a pressure belt. This twin belt fixing device includes a pad member for pressing the fixing belt toward the pressure roller, and this pad member is disposed apart from the suspension roller of the fixing belt.

However, in such fixing device using belts, the nip pressure is extremely lowered or lost somewhere in the fixing nip, and fixing failure may occur due to decrease or loss of the nip pressure.

### SUMMARY OF THE INVENTION

It is hence an object of the invention to provide an image heating apparatus capable of suppressing extreme decrease of pressure in the nip.

Further objects of the invention will be more clearly understood by reading the following detailed description with reference to the accompanying drawings.

To achieve the above-mentioned object, the present invention provides an image heating apparatus comprising:

an endless belt for heating an image on a recording material at a nip;

a nip forming member for forming the nip together with the belt;

a roller for rotatably supporting the belt at the nip; and

a pressure pad, disposed to form a gap between the pressure pad and the roller, for pressing the belt toward the nip forming member at the nip;

wherein the relation of
Y≧1×10⁸X²+2×10⁶X
0<Y<2.6×10⁷
is satisfied, where Y is the product of Young's modulus of the belt and thickness (Mpa·mm), and X is the product of length of the belt at the gap in moving direction and pressure per unit area at the gap (Mpa·mm).

### BRIEF DESCRIPTION OF THE DRAWINGS

FIG. 1 is a sectional structural diagram of fixing device in an embodiment of the invention;

FIG. 2 is a magnified sectional structural view showing a form of experiment;

FIG. 3 is a graph showing results of experiment;

FIG. 4 is a graphic table showing conditions of experiment; and

FIG. 5 is a sectional structural view of image forming apparatus in an embodiment of the invention.

### DETAILED DESCRIPTION OF THE PREFERRED EMBODIMENTS

Preferred embodiments of the present invention are describers below.

An image forming apparatus mounting a fixing device as an image heating apparatus is explained. The detail is described below with reference to the accompanying drawings.

(General Configuration of Image Forming Apparatus)

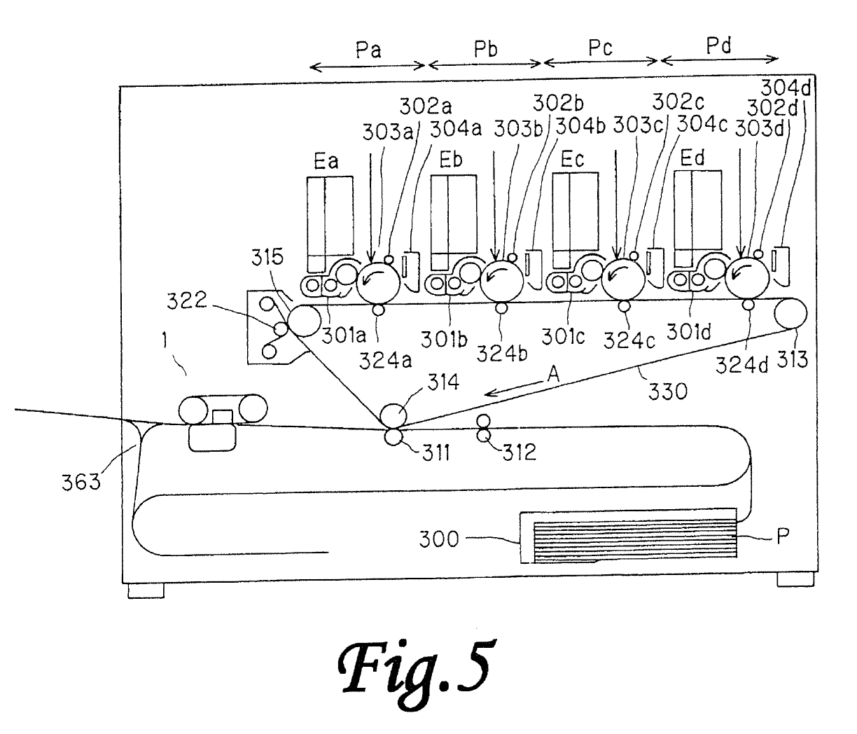

By referring to FIG. 5, a general configuration of an image forming apparatus is described.

The apparatus shown in FIG. 5 includes first, second, third, and fourth image forming portions Pa, Pb, Pc, Pd for constituting the image forming means, and toner images of different colors are formed through the process of latent image, development, and transfer.

The image forming portions Pa, Pb, Pc, Pd have their own image carriers, electrophotographic photosensitive drums 303a, 303b, 303c, 303d in this embodiment, and toner images of respective colors are formed on the photosensitive drums 303a, 303b, 303c, 303d. Adjacently to the each photosensitive drums 303a, 303b, 303c, 303d, an intermediate transfer member 330 is disposed. Toner images of colors formed on the photosensitive drums 303a, 303b, 303c, 303d are primarily transferred on the intermediate transfer member 330, and further transferred on a recording material p at second transfer unit. The recording material p on which toner images are transferred is heated and pressed by the fixing device 1 to fix the toner images, and discharged outside of the apparatus as recorded images.

The outer circumference of photosensitive drums 303a to 303d includes drum chargers 302a to 302d, development units 301a to 301d, primary transfer chargers 324a to 324d, and cleaners 304a to 304d. Above the apparatus, a light source device and a rotary polygon mirror, not shown, are installed.

Laser light emitted from the light source device is scanned by rotating the rotary polygon mirror, and the luminous flux of the scanning light is deflected by a reflection mirror, and is passed through fθ lens to be concentrated and exposed on the generators of the photosensitive drums 303a, 303b, 303c, 303d. As a result, latent images corresponding to the image signals are formed on the photosensitive drums 303a, 303b, 303c, 303d.

The development units 301a, 301b, 301c, 301d contain a specified amount of toners of yellow, magenta, cyan, and black as developing agents supplied from feed devices not shown. The development units 301a, 301b, 301c, 301d develop the latent images on the photosensitive drums 303a, 303b, 303c, 303d, and visualize as cyan toner image, magenta toner image, yellow toner image, and black toner image.

The intermediate transfer member 330 is rotated and driven in arrow direction at same peripheral speed as photosensitive drum 303.

The yellow toner image of first color formed and carried on the photosensitive drum 303a passes through the nip between a photosensitive drum 3 and the intermediate transfer member 330. In this process, by the electric field and pressure formed by primary transfer bias applied to the intermediate transfer member 330, the image is transferred intermediately on the outer circumference of the intermediate transfer member 330.

Similarly, the magenta toner image of second color, the cyan toner image of third color, and the black toner image of fourth color are sequentially transferred and overlaid on the intermediate transfer member 330, and a synthetic color toner image corresponding to the intended color image is formed.

Reference numeral 311 denotes a secondary transfer roller, which is borne and disposed in parallel to the intermediate transfer member 330 in press contact with its lower side. A desired secondary transfer bias is applied to the secondary transfer roller 311 from a secondary transfer bias source. The synthetic color toner image overlaid and transferred on the intermediate transfer member 330 is transferred on the recording material P in the following procedure. That is, the recording material P is supplied at specified timing to the contacting nip between the intermediate transfer member 330 and the secondary transfer roller 311, from the paper feed cassette 300 through a registration roller 312 and a pre-transfer guide. At the same time, secondary transfer bias is applied from the bias source. By this secondary transfer bias, the synthetic color toner image is transferred from the intermediate transfer member 330 to the recording material P.

After the process of primary transfer, the photosensitive drums 303a, 303b, 303c, 303d are cleaned by cleaners 304a, 304b, 304c, 304d respectively, and remaining transfer toners are removed to be ready for subsequent process of forming of latent images. Remaining toners and foreign matters on the intermediate transfer member 330 are wiped off from the surface of intermediate transfer member 330 by using a cleaning web (nonwoven fabric).

The recording material P on which toner images are transferred is sequentially sent into the fixing device 1 as image heating apparatus, and heat and pressure are applied to the recording material to fix the images, and the material is discharged from a discharge portion 363.

(Fixing Device)

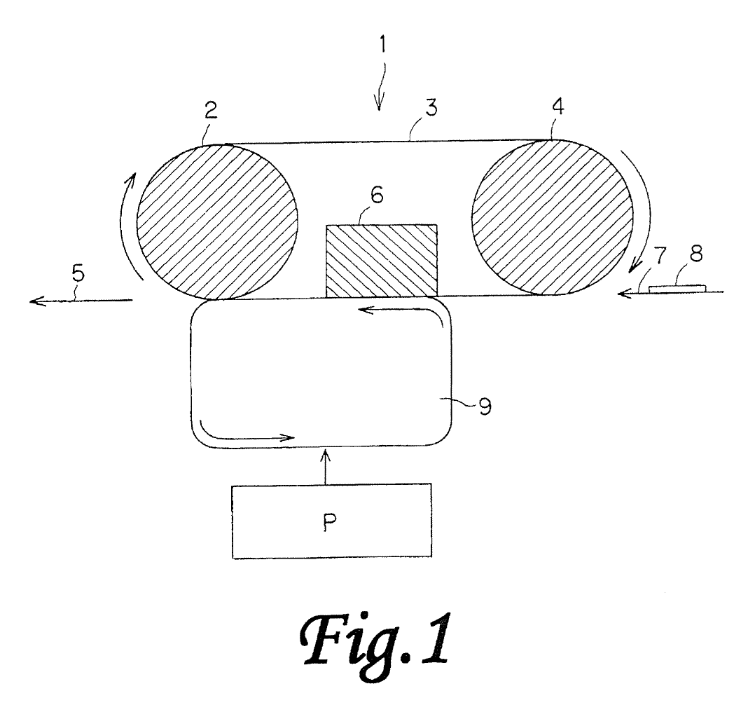

FIG. 1 is a sectional structural view of an embodiment of a belt fixing device as an image heating apparatus. As shown in FIG. 1, the belt fixing device 1 is mainly composed of a fixing belt 3 as an endless belt, and a pressure member 9 as a nip forming member.

The fixing belt 3 is stretched to be able to circulate between a driving roller (fixing roller) 2 and a tension roller 4 installed in the belt. The driving roller (fixing roller) 2 and a pressure pad 6 pinch and press the fixing belt 3 together with the pressure member 9, and a nip is formed. The pressure member 9 is pressed against the fixing belt 3 by means of a pressing mechanism P.

The fixing belt 3 and the pressure member 9 are in press contact with each other at the nip. At the nip between these fixing belt 3 and the pressure member 9, recording material 7 carrying an unfixed toner image 8 is carried and conveyed, and the unfixed toner image 8 is fixed on the recording material 7.

Base material of the fixing belt 3 is preferred to be a metal member in the case of electromagnetic induction heating system, but the material is not particularly specified. Thickness of the base material of the fixing belt 3 is not specified either. But if the base material is too rigid and too thick, a very large tensile load is required for suspending the fixing belt 3, and the conveying performance and durability of the belt are extremely lowered. Hence, the material is preferred to be softer than Fe (Young's modulus: 2.058×10⁵ (Mpa)), and thickness of the base material is preferred to be thinner than 200 (μm). To enhance the contact degree with the toner, the fixing belt 3 is preferred to include an elastic layer. Further, as a surface layer on this elastic layer, it is preferred to form a parting layer excellent in parting property from toner and heat resistance. In this example, therefore, the fixing belt is formed by laminating the base material, elastic layer, and parting layer in this order.

The driving roller (fixing roller) 2 is formed in a specified outside diameter, by covering the surface of metal core made of aluminum or stainless steel and the like, with an elastic layer of rubber or the like in a specified thickness.

The tension roller 4 is a rigid body of metal or heat resistant resin, and the fixing belt 3 is stretched to be able to be circulated. Pulling direction of tension roller 4 is not particularly specified.

The pressure pad 6 is a rigid base body of metal, this base body is coated with a resin sheet excellent in sliding performance with the fixing belt 3.

The pressure member 9 is either roller-type or belt-type, and in this example the pressure member 9 is a pressure roller. In this case, the pressure roller is a roller of large diameter so as to press the fixing belt from the opposite side to the pressure pad to the opposite side to the driving roller 2. In the case of pressure roller, it is more preferable to form an elastic layer on the surface of metal core of aluminum or stainless steel and the like, in order to obtain surface layer excellent in parting property and heat resistance, and uniformity of image.

When a pressure belt is used as a pressure member, a pressure pad is also installed at the inside of the pressure belt, and two pressure pads hold and enclose the fixing belt and pressure belt, and thereby a nip is formed. In the case of pressure belt, it is preferred to form elastic layer and parting layer on the base material. This pressure belt, same as the fixing belt, requires a considerably large tensile load for suspending the pressure belt if the base material is too rigid or too thick, and the conveying performance and durability of the belt are extremely lowered. Hence the material is preferred to be softer than Fe (Young's modulus: 2.058×10⁵ [Mpa]), thinner than 200 [μm].

In this configuration, the fixing device of the embodiment is specified.

According to the study by the present inventors, in the belt fixing device, when the base material of the fixing belt 3 is less rigid, the nip pressure is extremely decreased or lost in the nip, and it is found that the fixing performance is impaired. Also when the gap (spacing distance of fixing belt in moving direction) is increased between the driving roller (fixing roller) 2 and the pressure pad 6, the nip pressure is extremely decreased or lost in the nip, and it is found that the fixing performance is impaired. As a result, in either case, uneven gloss and other problems are found in the image after fixing.

The reason why the driving roller 2 and pressure pad 6 are disposed across a gap is that the driving roller has a rubber layer as an elastic layer on the surface, and that the torque required to rotate the driving roller is excessively increased if it is disposed in contact with the pressure pad.

Therefore, in the gap between the driving roller 2 and the pressure pad 6, any member receiving the pressing load by the pressure member 9 at the inner side of the fixing belt 3 cannot be disposed. Hence, desired contact pressure may not be obtained in the gap in this nip.

The present inventors attempted to heighten the rigidity of fixing belt 3 sufficiently. That is, if gap is formed between the driving roller 2 and the pressure pad 6, it is attempted not to lower the pressure extremely if load from the pressure member 9 is applied to the portion of the belt corresponding to this gap. Therefore, the received load can be directly held by the fixing belt 3 alone, and a desired nip contact pressure can be obtained in the nip.

In unloaded state, however, since the cylindrical endless belt is stretched by applying tension by two rollers, it is not preferred to increase the rigidity of fixing belt 3 too high from the viewpoint of durability.

The inventors experimented to evaluate occurrence of defect such as uneven gloss, by fixing the toner image by varying the material and thickness of the base material of the fixing belt, the length along the moving direction of the fixing belt in the gap, and pressure per unit area in the gap.

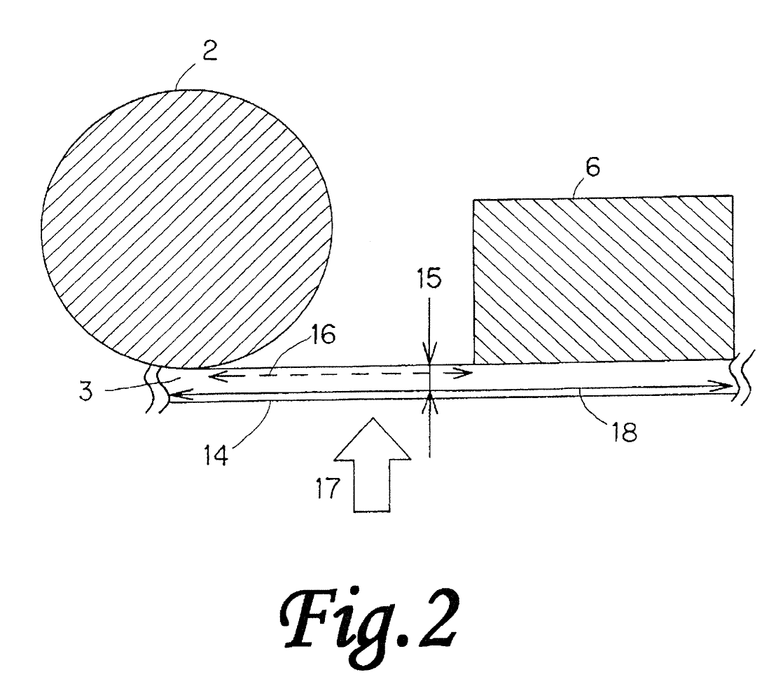

FIG. 2 is a magnified view of FIG. 1, and is a sectional structural view of nip 18 for explaining clearly the definition of parameters changed in the experiment.

The driving roller (fixing roller) 2 includes a core of SUS of 20 mm in outside diameter, of which surface is coated with a silicon rubber layer of 0.75 mm in thickness. The pressure pad 6 is a rigid body of SUS, of which surface contacting with the fixing belt 3 is coated with a resin sheet excellent in sliding performance.

As base material of fixing belt 3, plural types were tested from soft to hard materials. Specifically, Young's modulus ranges from 3.7×10⁴ (Mpa) to 2.1×10⁵ (Mpa). The fixing belt 3 is composed of three layers.

Thickness 15 of fixing belt base material is 30, 80, 150, and 200 μm. Length 16 of gap is defined to be the distance of the driving roller (fixing roller) 2 and the pressure pad 6 along belt moving direction inside of fixing belt not contacting with the fixing belt 3.

Pressure sensor 14 is means for measuring the nip contact pressure. Specifically, the pressure sensor 14 is “Tactile Sensor System I-SCAN” (a trade name). This sensor 14 is capable of measuring the pressure at sensor thickness of 0.1 mm, or pitch of 1 mm or 0.65 mm in the belt moving direction.

In this example, supposing the pressure to be uniform and not uniform in the gap, to obtain an averaged index, pressure per unit area in the gap is calculated. Pressure 17 per unit area in the gap is defined by summing the pressures occurring at measuring points positioned in the gap determined by the pressure sensor 14, and dividing by the nip length in length×depth direction of the gap.

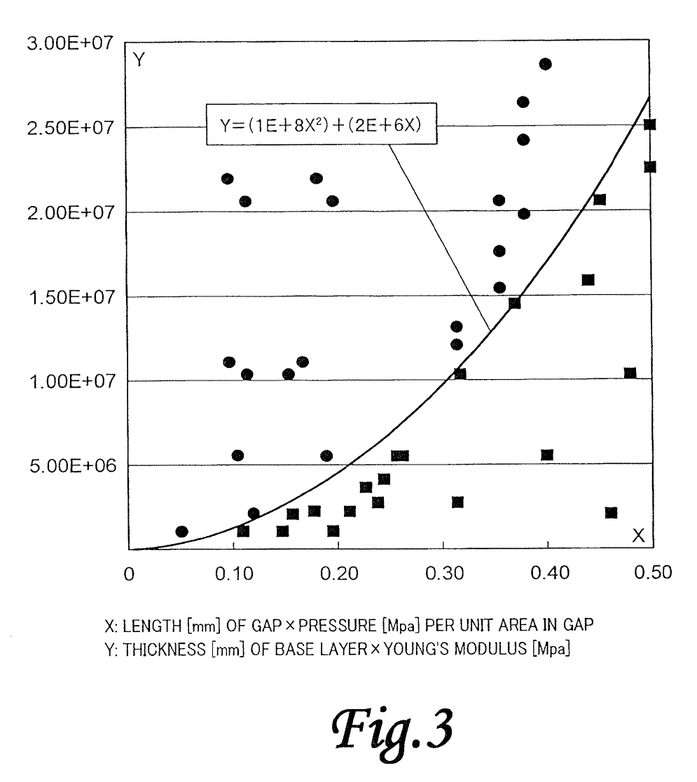

FIG. 3 shows results of the experiments. The present inventors obtained, from numerous experiments, the correlative relation with uneven gloss and other defects as qualitative knowledge, when the rigidity of the fixing belt is heightened. For example, when the belt rigidity is heightened, if the pressure per unit area in the gap is same, occurrence of uneven gloss or other defective image can be suppressed if the length of the gap is extended. Similarly, when the belt rigidity is higher, if the gap length is same, occurrence of uneven gloss or other defective image can be suppressed if the pressure per unit area in the gap is decreased. It has been also known qualitatively that favorable images are obtained, without occurrence of uneven gloss or other image defects, when the minimum contact pressure of the gap is 0.01 (Mpa) or more. In addition, when the tension applied to the fixing belt is 30 kgf or less, it has been qualitatively known that there is no effect on the result of experiment.

In FIG. 3, the X-axis and Y-axis are defined as follows. That is, the X-axis refers to length [mm] along fixing belt moving direction in the gap×pressure [Mpa] per unit area in gap, and the Y-axis refers to the base layer thickness [mm]×Young's modulus [Mpa]. In FIG. 3, the bullet shows a favorable image is obtained (minimum contact pressure in the gap of 0.01 [Mpa] or more), and the black square shows a defective image is obtained (minimum contact pressure in the gap of less than 0.01 [Mpa]).

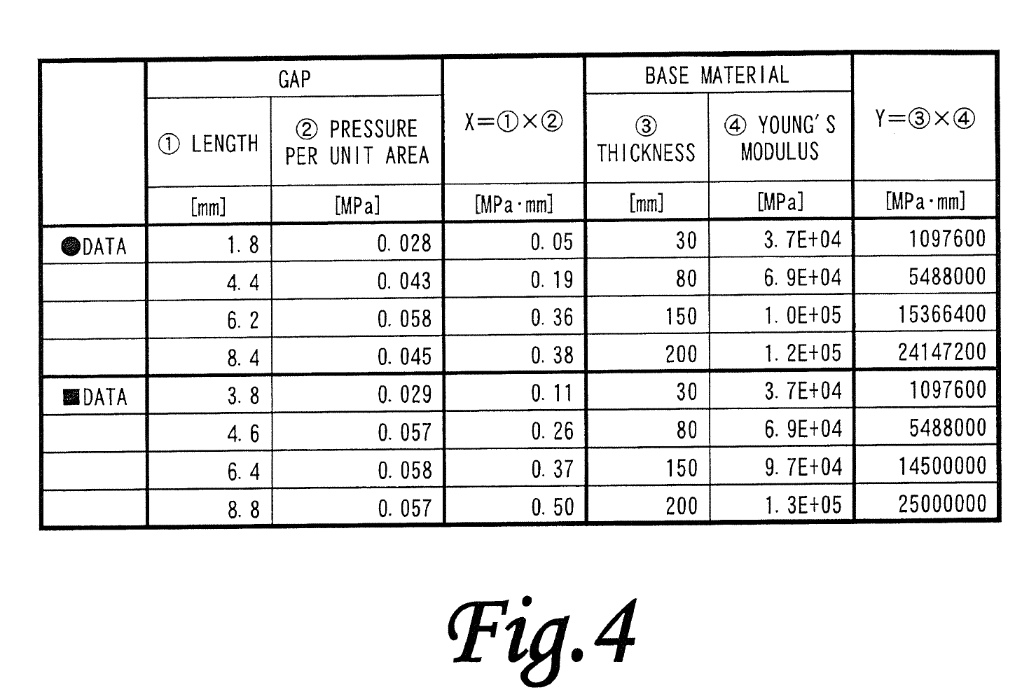

FIG. 4 shows parts of setting conditions in the results of FIG. 3.

In FIG. 3 and FIG. 4, “1×10^{A}” is indicated as “1E+A”. That is, as mentioned below, “Y=(1E+8X)+(2E+6X)” corresponds to “Y=1×10⁸X²+2×10⁶X”.

As clear from FIG. 3, by heightening the rigidity of fixing belt, it is known that occurrence of defective image such as uneven gloss can be suppressed. On the other hand, if the rigidity of the fixing belt is not so high, by shortening the length of the gap or by lowering the pressure per unit area in the gap, it is known that occurrence of defective image such as uneven gloss can be suppressed.

By verifying the results, the present inventors have found that it is enough to satisfy the following conditions.

That is, the curve passing the boundary of bullet and black square in FIG. 3 is approximately determined as follows.
Y=1×10⁸X²+2×10⁶X (formula 1)

Therefore,
Y≧1×10⁸X²+2×10⁶X (formula 2)
0<Y<2.6×10⁷ (formula 3)

In the above formulae,

X: length [mm] of gap×pressure [Mpa] per unit area in gap

Y: thickness [mm] of belt base layer×Young's modulus [Mpa] of belt base layer

As far as the relation of formula (2) and formula (3) is satisfied, it is known that occurrence of uneven gloss or other defective image can be suppressed. By the reason mentioned above, the tension applied to the fixing belt is defined to be 30 kgf or less.

There is an evident reason that Y is limited to a value larger than 0. The value of Y is preferred to be less than 2.6×10⁷. If the value is larger, a considerable tensile load is required for suspending the fixing belt, and the conveying performance, durability and power saving of the belt are extremely lowered. Supposing Y to be less than 2.6×10⁷, X is defined to be less than 0.5 from boundary curve (1).

In this example, as a result of above-described verification experiments, it is preferred that the gap length is shorter, and hence the gap length in FIG. 4 is set in the condition of 1.8 (mm).

Herein, the fixing belt is explained as an example of the endless belt of image heating apparatus, but the invention can be similarly applied to a pressure belt. In this case, the fixing side is the fixing roller, and the vertical relation of the fixing device in the illustrated embodiment is inverted.

The image heating apparatus of the invention is not limited to the application as fixing device for fixing the unfixed toner image formed in the recording material. For example, the image heating apparatus can be applied in the use of fixing temporarily the toner image, or the use of enhancing the glossiness of image by reheating the already fixed toner image.

This application claims priority from Japanese Patent Application No. 2005-266011 filed Sep. 13, 2005, which is hereby incorporated by reference, herein.

What is claimed is:

1. An image heating apparatus comprising:
an endless belt for heating an image on a recording material at a nip;
a nip forming member for forming the nip together with the belt;
a roller for rotatably supporting the belt at the nip; and
a pressure pad, disposed to form a gap between the pressure pad and the roller, for pressing the belt toward the nip forming member at the nip;
wherein the relation of
Y≧1×10⁸X²+2×10⁶X
0<Y<2.6×10⁷
is satisfied, where Y is the product of Young's modulus of the belt and thickness (Mpa·mm), and X is the product of length of the belt at the gap in moving direction and pressure per unit area at the gap (Mpa·mm).

2. The image heating apparatus according to claim 1, wherein the roller is a driving roller having an elastic layer on the surface for driving the belt.

3. The image heating apparatus according to claim 1, wherein the belt is disposed at a side contacting with the image on the recording material.
